(19) United States
(12) Patent Application Publication
(10) Pub. No.: US 2007/0229303 A1
(43) Pub. Date: Oct. 4, 2007

(54) Fluid Level Detector and Alarm Apparatus

(76) Inventor: Willliam R. Collier, Esterel (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/575,850

(22) PCT Filed: Oct. 18, 2004
(86) PCT No.: PCT/CA04/01837

§ 371 Date: Feb. 14, 2007

Related U.S. Application Data
(60) Provisional application No. 60/511,596, filed on Oct. 16, 2003.

(51) Int. Cl. H04B 13/02

(52) U.S. Cl. 340/850

(57) ABSTRACT

A fluid level detector and alarm apparatus for detecting a fluid level in a liquid receiving open-top vessel such as sinks, tubs and the like, comprising: a housing being connectable to the vessel so as to be positioned within the vessel. A sound emitter is positioned within the housing, the sound emitter being actuatable to emit a sound alarm. A circuit interconnects the sound emitter to the power source and has opposed ends emerging out of the housing. A floater unit has a conductive member thereon and is operatively connected to the housing so as to be displaceable with respect to the housing to a contacting position in which the conductive member contacts the opposed ends of the circuit to actuate the sound emitter, whereby the floater unit is displaced to the contacting position by buoyant forces exerted on the floater unit as a result of the fluid level in the vessel reaching the predetermined level, such that a sound alarm is emitted.

### CROSS-REFERENCE TO RELATED APPLICATION

The present application claims priority on U.S. Provisional Patent Application 60/511,596, filed on Oct. 16, 2003.

### TECHNICAL FIELD

The present invention generally relates to fluid level detection and signalling for bathtubs and other liquid receiving open-top vessels for domestic use, such as sinks, tubs and the like.

### BACKGROUND ART

Filling a bathtub or a like vessel with fluid has always presented a danger of overflow if the vessel is not continuously monitored. Vessels that require a long amount of time to fill, such as bathtubs, are often unattended as they are filled, and this has lead in many instances to damage caused by the overflow of fluid.

Devices for detecting fluid levels have been developed to resolve this problem. Such devices alert the user by way of audible alarm when the fluid level has reached a desired level. This is a conceptually simple solution, but the prior art devices used to accomplish it are often overly involved mechanisms whose floater and/or diaphragm devices interact with audible alarms in unnecessarily complicated ways. Other prior devices for detecting fluid levels are watertight housing units containing complex inner workings. It would be desirable to provide a simple, dependable apparatus for detecting a fluid level that audibly signals that the desired fluid level has been reached.

Moreover, the known devices for detecting and signalling fluid levels are electrically powered by low-voltage batteries. Accordingly, there is a risk that the user will be unaware when the energy level of the batteries in such devices has become too low to power the alarm, so that the device is likely to fail in indicating that the desired fluid level has been reached in the open-top vessel.

### SUMMARY OF INVENTION

It is an aim of the present invention to provide a novel fluid level detection and alarm apparatus for sounding an alarm when fluid in an open-top vessel reaches a desired level.

It is a further aim of the present invention to provide a fluid level detection and alarm apparatus that substantially overcomes the disadvantages of the prior art.

It is a still further aim of the present invention to provide a fluid level detection and alarm apparatus that is easy-to-use, simple, and inexpensive to manufacture.

It is a still further aim of the present invention to provide a fluid level detection and alarm apparatus that indicates when a low level of energy in its power source has been reached.

Therefore, in accordance with the present invention, there is provided a fluid level detector and alarm apparatus for use in a liquid receiving open-top vessel, comprising: a housing being connectable to the vessel so as to be positioned within the vessel, the housing being adapted to receive a power source therein; a sound emitter positioned within the housing, the sound emitter being actuatable to emit a sound alarm; a circuit within the housing for interconnecting the sound emitter to the power source, the circuit having opposed ends emerging out of the housing; and floater means having a conductive member thereon and being operatively connected to the housing so as to be displaceable with respect to the housing to a contacting position in which the conductive member contacts the opposed ends of the circuit to actuate the sound emitter; whereby the floater means is displaced to the contacting position by buoyant forces exerted on the floating means as a result of the fluid level in the vessel reaching the predetermined level, such that a sound alarm is emitted.

Further in accordance with the present invention, there is provided a fluid level detector and alarm apparatus for use in a liquid receiving open-top vessel, comprising: a housing being connectable to the vessel so as to be positioned within the vessel, the housing being adapted to receive a power source therein; a sound emitter positioned within the housing, the sound emitter being actuatable to emit a sound alarm; a circuit within the housing for interconnecting the sound emitter to the power source, the circuit being triggered by the fluid level of the vessel reaching the predetermimed level such that a sound alarm is emitted by the sound emitter; and a controller in the circuit, the controller being adapted to measure a power level of the power source, and actuate an indicator to indicate a low power level.

### BRIEF DESCRIPTION OF DRAWINGS

A preferred embodiment of the present invention will now be described with reference to the accompanying drawings in which:

FIG. 1 is a front perspective view of a fluid level detector and alarm apparatus in accordance with a preferred embodiment of the present invention;

FIG. 2 is a rear perspective view of the apparatus of the present invention;

FIG. 3 is a perspective view showing an interior of a housing unit of the apparatus of the present invention, with electronic components removed;

FIG. 4 is a perspective view of the apparatus of the present invention, with a floater housing of a floater unit removed to illustrate an interaction between a floater and the housing unit;

FIG. 5 is a bottom perspective view, enlarged, of the apparatus of the present invention with the floater removed; and

FIG. 6 is a schematic view of a circuit used in the apparatus in accordance with the present invention.

### DESCRIPTION OF PREFERRED EMBODIMENTS

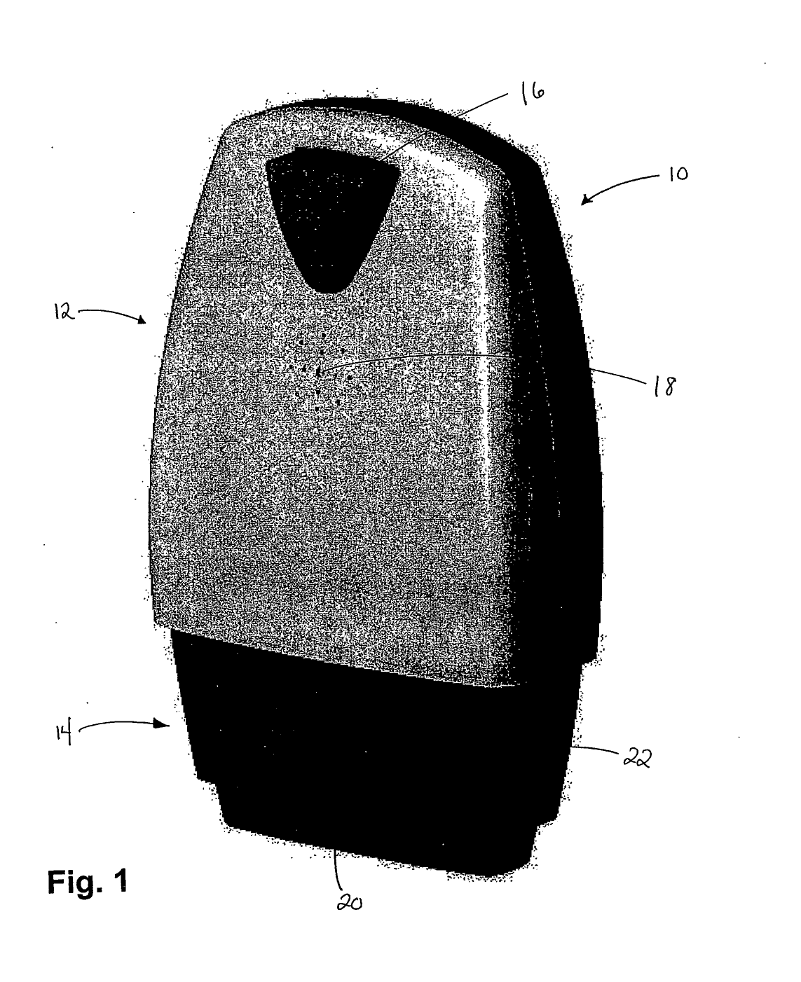

Referring to the drawings and, more particularly, to FIG. 1, an apparatus in accordance with the present invention is generally shown at 10. The apparatus 10 has an housing unit 12 and a floater unit 14.

The housing unit 12 is generally watertight and has, on its front surface, an on/off button 16 and a speaker output 18 (i.e., holes through the housing unit wall such that a sound emitter within the housing unit 12 emits sound out of the housing unit 12). The button 16 activates and deactivates the apparatus 10. The button 16 can be any type of on/off switch suitable for the apparatus 10. As will be described hereinafter, the button 16 is preferably used with a light source, such as a light emitting diode (LED), that indicates that the apparatus 10 is turned on.

The floater unit 14 is removably attached to the housing unit 12. The floater unit 14 comprises a floater 20 that is displaceable within the floater housing 22 as a result of buoyant forces created by the rising level of the fluid. Both the floater 20 and the floater housing 22 are shaped in a downward taper, in order for the floater 20 to remain within the floater housing 22 while being displaceable upwardly to come into contact with the housing unit 12. The floater housing 22 is preferably releasably connected to the housing unit 12, so as to clean an interior thereof, as well as the floater 20.

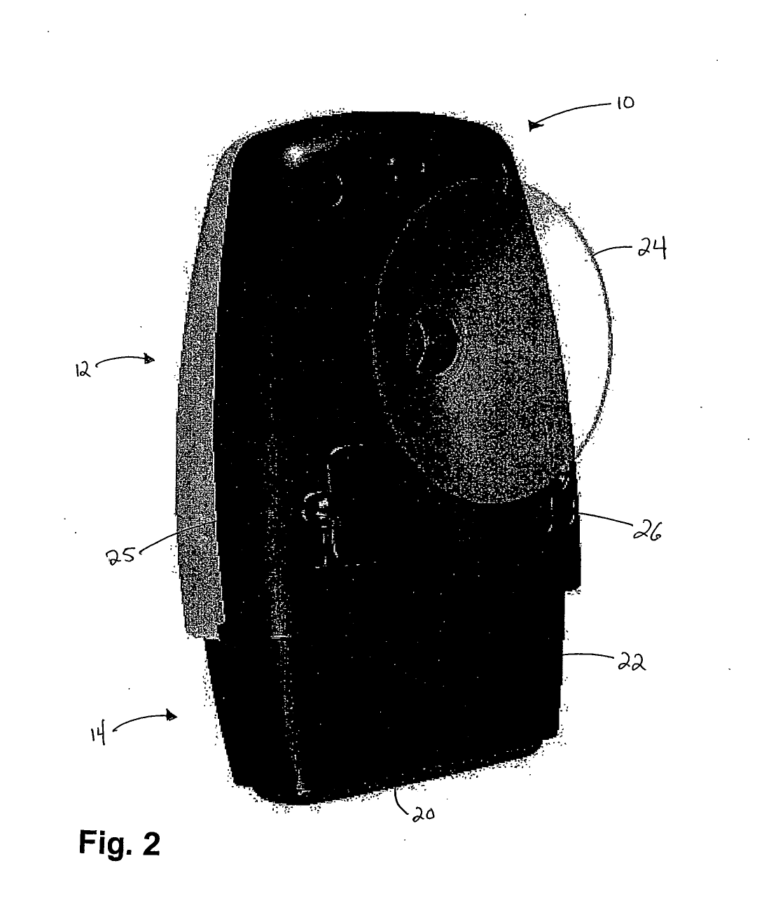

Referring to FIG. 2, the apparatus 10 is shown having a suction cup 24 used to attach the apparatus 10 to the inside surface of an open-top vessel. In accordance with alternative embodiments of the present invention, other devices could be used to attach the apparatus to the inside surface of a vessel, such as Velcro™ strips, or a hook releasably connected to an upper edge of the tub.

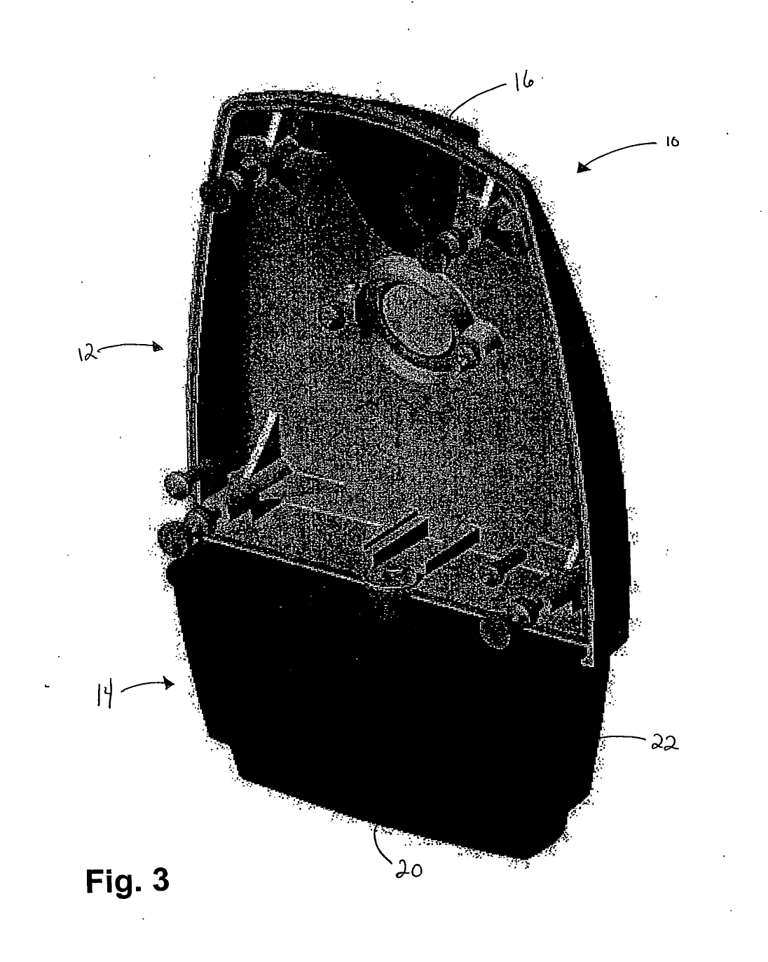

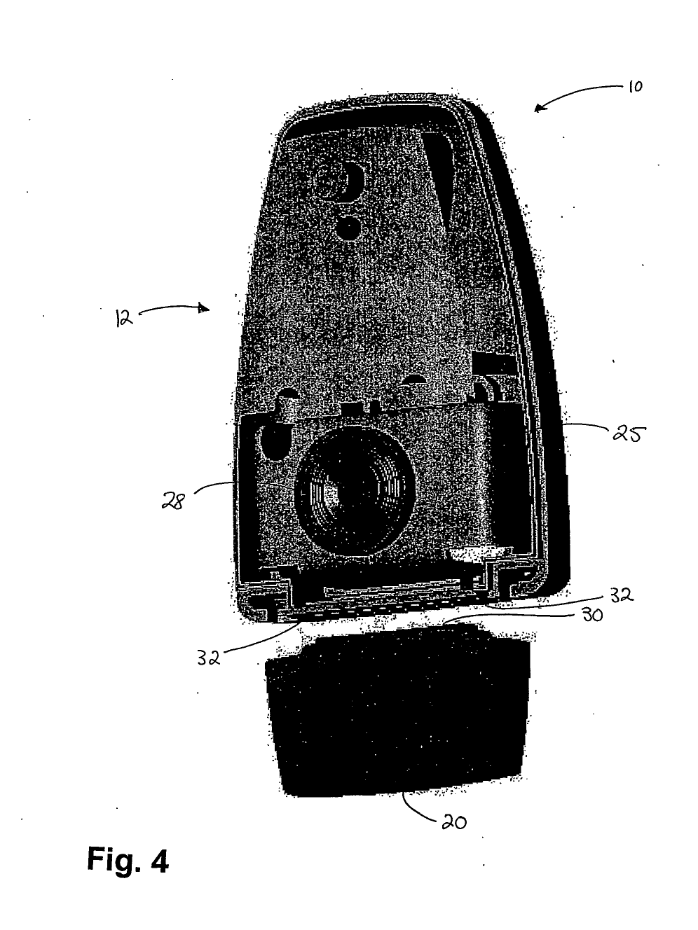

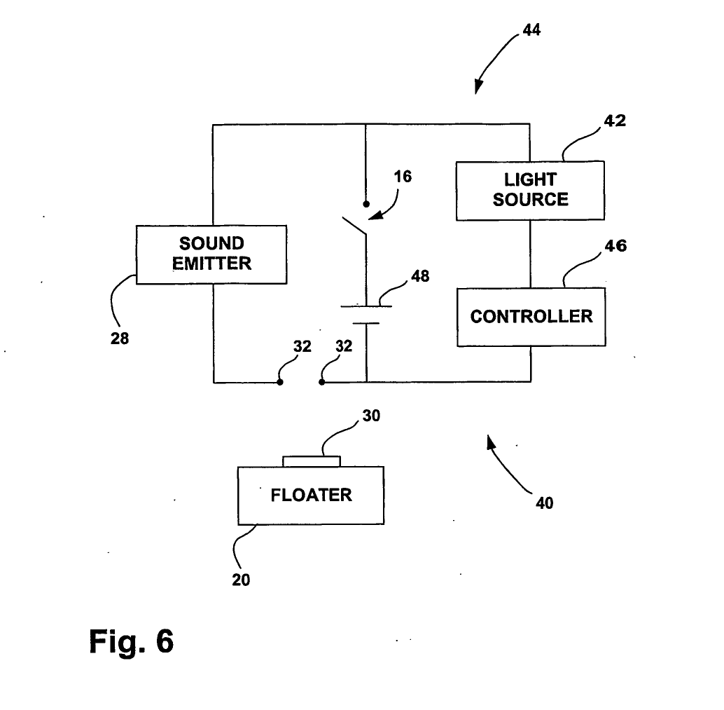

Referring concurrently to FIGS. 3 and 4, an interior of the housing unit 22 is illustrated. The housing unit 22 encloses the electronic components that will cooperate with the power source, lodged in compartment 25, to generate the audible signal indicating a limit fluid level. However, for simplicity purposes, the electronic components have been removed from FIG. 3, but are schematically illustrated in FIG. 6 by way of circuit 40. The button 16 is shown having a hollow body. In the preferred embodiment of the present invention, the button 16 is made of a translucent material and receives therein a light source that will indicate that the apparatus 10 is activated.

Referring to FIG. 2, a panel 26 covers the battery compartment 25. In the preferred embodiment the panel 26 is sealingly attached to a remainder of the housing unit 12 using screws, but other suitable fasteners or fastening mechanisms could be used. Furthermore, alternative low voltage power sources could be used, but live wires from a domestic power source are not to be connected to the apparatus 10, as the apparatus 10 will be in contact with water.

Referring to FIG. 4, the housing unit 12 contains a sound emitter 28 (e.g., speaker) which connects to the circuit 40 (FIG. 6) and is positioned within the housing unit 12 so as to output its audible signal through the speaker output 18.

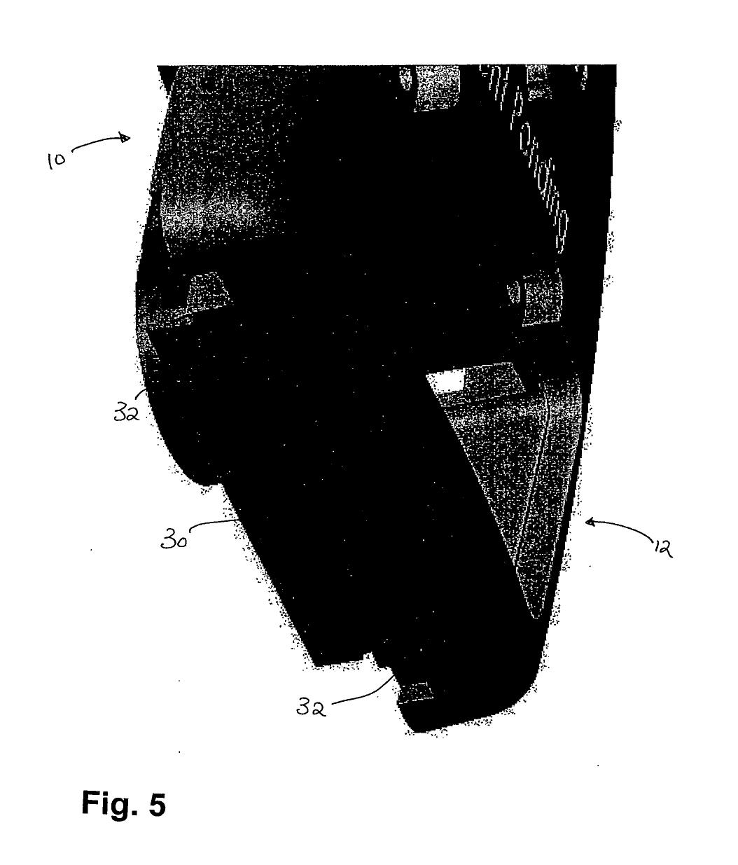

In the preferred embodiment of the present invention, the circuit 40 is an open circuit that will be closed to generate an alarm signal by way of the floater 20 (FIG. 1) contacting opposed contact ends of the circuit 40. As shown concurrently in FIGS. 4 to 6, the floater 20 has on a top surface thereof a conductive plate 30, which will contact the contact ends 32 on the lower outer surface of the housing unit 12. This closes the circuit 40, such that the sound emitter 28 emits audible alarm. It is pointed out that the circuit 40 must also be closed at the button/switch 16 for the sound emitter 28 to emit the audible alarm.

Referring to FIG. 6, the button/switch 16 is shown having a light source 42, which is actuated when the apparatus 10 is turned on. Accordingly, the light source 42 indicates to the user of the apparatus 10 that the latter is activated, informing the user that the vessel being filled with fluid may be left unattended as an audible alarm will be triggered once the fluid level in the vessel reaches a predetermined desired level.

In accordance with an alternative embodiment of the present invention, the light source 42 is in a loop 44 provided in the circuit 40. The loop 44 has a controller 46 (e.g., chip board) that will ensure that the power source, illustrated at 48 in FIG. 6, has sufficient power for the apparatus 10 to operate. Accordingly, the controller 46 is programmed to monitor the power source 48, such that a low voltage (below preset limits) is detected. Various methods and indicators can be used to indicate to the user that the power level is too low (i.e., signalling mode of the controller), such as a flashing signal from the light source 42 when the apparatus 10 is activated, or the use of another light source (not shown) of another color (e.g., red) to indicate the low power level.

It is pointed out that any other suitable circuit may be used in accordance with the present invention, provided the key features of the present invention are achievable with such circuits.

In order to use the apparatus 10 of the present invention, the user positions the apparatus 10 in a bathtub or other liquid receiving open-top vessel for domestic use, such as a sink, a tub and the like. The apparatus 10 is positioned such that bottom of the floater housing 22 is generally where the desired fluid level (according to the user) of the vessel should be. A marker could be provided on the floater unit 14 to indicate at which level on the apparatus 10 the alarm will be triggered.

Once the apparatus 10 is in position, the apparatus 10 is activated, whereby the light source 42 will be turned on. If the power level of the power source 48 is relatively low, the user is warned that the apparatus 10 can not be used, e.g., by a flashing signal. If the apparatus 10 has sufficient power to operate, the user may fill the vessel.

Means for indicating the temperature of the fluid in the vessel or enclosure could also be provided for in the apparatus.

In addition to, or in lieu of, the alarm, a semi-conductor chip that can be programmed with verbal, musical or other sound cues is provided.

The housing of the device could be formed in fanciful shapes, such as the shapes of animals, fairy-tale or nursery rhyme figures, or cartoon characters. The housing of the apparatus could also be adapted to receive detachable fanciful shapes.

It is within the ambit of the present invention to cover any obvious modifications of the embodiments described herein, provided such modifications fall within the scope of the appended claims.

1. A fluid level detector and alarm apparatus for use in a liquid receiving open-top vessel, comprising:
a housing being connectable to the vessel so as to be positioned within the vessel, the housing being adapted to receive a power source therein;
a sound emitter positioned within the housing, the sound emitter being actuatable to emit a sound alarm;
a circuit within the housing for interconnecting the sound emitter to the power source, the circuit having opposed ends emerging out of the housing; and
floater means having a conductive member thereon and being operatively connected to the housing so as to be displaceable with respect to the housing to a contacting position in which the conductive member contacts the opposed ends of the circuit to actuate the sound emitter;
whereby the floater means is displaced to the contacting position by buoyant forces exerted on the floating means as a result of the fluid level in the vessel reaching the predetermined level, such that a sound alarm is emitted.

2. The fluid level detector and alarm apparatus according to claim 1, further comprising a switch in the circuit, the switch being displaceable to an on position for the fluid level detector apparatus to be activated.

3. The fluid level detector and alarm apparatus according to claim 2, further comprising a light source in the circuit, the light source being turned on when the fluid level detector apparatus is activated.

4. The fluid level detector and alarm apparatus according to claim 3, further comprising a controller in the circuit, the controller being adapted to measure a power level of the power source, and actuate the light source in a signalling mode to indicate a low power level.

5. The fluid level detector and alarm apparatus according to claim 1, wherein the floater means has a floater and a floater housing operatively connecting the floater to the housing.

6. The fluid level detector and alarm apparatus according to claim 5, wherein the conductive member is a conductive plate on a top surface of the floater, with the opposed ends of the circuit being positioned on a bottom end of the housing.

7. The fluid level detector and alarm apparatus according to claim 5, wherein the floater housing is releasably connected to the housing unit.

8. A fluid level detector and alarm apparatus for use in a liquid receiving open-top vessel, comprising:
a housing being connectable to the vessel so as to be positioned within the vessel, the housing being adapted to receive a power source therein;
a sound emitter positioned within the housing, the sound emitter being actuatable to emit a sound alarm;
a circuit within the housing for interconnecting the sound emitter to the power source, the circuit being triggered by the fluid level of the vessel reaching a predetermined level such that a sound alarm is emitted by the sound emitter; and
a controller in the circuit, the controller being adapted to measure a power level of the power source, and actuate an indicator to indicate a low power level.

9. The fluid level detector and alarm apparatus according to claim 8, further comprising a switch in the circuit, the switch being displaceable to an “on” position for the fluid level detector apparatus to be activated.

10. The fluid level detector and alarm apparatus according to claim 9, further comprising a light source in the circuit, the light source being turned on when the fluid level detector apparatus is activated.

11. The fluid level detector and alarm apparatus according to claim 10, wherein the indicator is the light source being actuated by the controller in a signalling mode to indicate a low power level.
